(19) United States
(12) Patent Application Publication
(10) Pub. No.: US 2015/0173516 A1
(43) Pub. Date: Jun. 25, 2015

(54) PILLOW FOR PROVIDING IMPROVED COMFORT WHILE SEATED

(71) Applicant: William Erbe, Reno, NV (US)

(72) Inventor: William Erbe, Reno, NV (US)

(21) Appl. No.: 14/576,419

(22) Filed: Dec. 19, 2014

Related U.S. Application Data
(60) Provisional application No. 61/918,067, filed on Dec. 19, 2013.

(51) Int. Cl. A47C 7/38; B60N 2/48; A47G 9/10

(52) U.S. Cl. CPC A47C 7/383; A47G 9/1081; B60N 2/48; A47G 2009/1018

(57) ABSTRACT

An article for improved support of at least the neck of a person seated on a seat having a back or head rest that extends at least to the level of the neck of a seated person of average height. The article includes: a base member made of a first resilient material and having a front main surface divided into an upper portion and a lower portion; and two lateral support members made of the first, or a second, resilient material, each support member being positioned along a respective lateral edge of the base member and each having a rear length portion that extends rearwardly from the base member past a rear main surface and a front length portion that extends forwardly from the base member past the front main surface.

### BACKGROUND OF THE INVENTION

The present invention relates to an article, or pillow, that provides improved comfort for a person who is seated on a seating article having a relatively high back or head rest.

Many articles for this purpose are already known and many of them do provide some degree of comfort. However, none of the known articles has been found to provide an optimum level of comfort. Therefore, none of the known articles have been found to be totally satisfactory.

### BRIEF SUMMARY OF THE INVENTION

The present invention provides a novel support pillow for a seated person, which promotes comfort, particularly when the person is seated for long periods, and not only comfortably supports the back of the neck and, preferably, the lower part of the back of the head, but is also constructed to deform automatically to embrace the sides of the neck, and preferably also the sides of the lower part of the head, thus constituting, in effect, a neck cradle.

The pillow thus provides head and neck alignment with lateral, i.e., sideways stability of at least the neck of a human user resting against a seat back.

The pillow has a neck support portion that is contoured to provide comfortable support for the back of the user's neck and, preferably, also for the occipital portion of the skull.

The pillow is comprised of a base member that provides a soft neck support, and two lateral support members that also perform a rocker function. The lateral support members and at least a portion of the base member that extends between the lateral support members together form a rocker lateral support system.

All directions and orientations described herein relate to the orientation of the pillow when being used to perform its supporting function.

The base member and lateral support members are preferably made of a foam material, such as a urethane foam.

A pillow according to the invention may be made in one piece having a uniform, homogeneous composition and uniform, homogeneous physical properties, such as resiliency and compressibility.

Alternatively, the base member is made from a material different from the lateral support members and the material of the lateral support members is stiffer, i.e. is less compressible, than the material of the base member.

Embodiments of a pillow according to the invention have one or more of the following features:
They use the mechanics of a posterior pressure lever to self adjust the sides in the center of the cervical area and not a uniform linear space;
They are constructed to rotate, or pivot, when pressed against a seat back by the user's neck, and possibly by the head and upper back, to provide an optimum orientation between the user and the pillow;
They employ a lordotic support, i.e., a support for the concave posterior of the neck, which contacts the user's neck to provide support for the natural curvature of the neck. Additionally, they impede forward flexing of the user's neck and head;
They provide an additional thoracic extension that supports the upper back from the top of the shoulder blades (interscapular area @T4). This decreases stress on the neck (cervical spine) by gently tractioning the neck. by distributing contact substantially equally from this interscapular area upward (superior) to the base of the skull (occiput);
They include the base member that is contoured and preferably made of a soft, resilient foam, for example HR10 foam, in contact with the user. The lateral support members may have the same composition as, and be integral with, the base member, or are constructed of a firmer density material to provide an additional supportive structure;
They have a functionally medial taper and a superior and inferior taper to allow head/neck extension, lateral stabilization, cervical lordotic support and cervical length adjustability;
They use the pressure of the neck, primarily or exclusively, to initiate the lateral support to the neck (cervical spine);
They support the head to the base of the inferior aspect of the occiput (base of the skull). This feature allows the user to rest his or her head against the seat back, or head rest, to prevent the seat back from further pushing the head forward because of the presence of the device;
They provide lateral support by the action of the lateral support members, and maintain lateral and lordotic support to the neck and a slightly superior direction to the head, similar to a gentle axial traction;
They preferably have an upper extent that is just below the user's ears.

### BRIEF DESCRIPTION OF THE DRAWINGS

FIG. 1 is a side view of one preferred embodiment of a pillow according to the invention.

FIG. 2 is a front view of the embodiment shown in FIG. 1.

FIG. 3 is a rear view of the embodiment shown in FIG. 1.

FIG. 4 is a top view of the embodiment shown in FIG. 1 in an undeformed state, when no force is being applied to the pillow.

FIG. 5 is a top view of the embodiment shown in FIG. 1, showing a deformed state, as it would respond to rearward pressure applied by the neck of a user.

FIG. 6 is a side view showing the pillow in use.

FIG. 7 is a cross-sectional view along line 7-7 of FIG. 2.

FIG. 8 is a perspective view of an embodiment of a lateral support member constituting one component of the pillow according to the invention.

FIG. 9 is a view similar to that of FIG. 2, showing a second embodiment in which the pillow is made from a single piece of material.

FIG. 10 is a view similar to that of FIG. 4, showing the second embodiment.

FIG. 11 is a view similar to that of FIG. 1, showing an alternative form of the pillow according to either embodiment provided with a cover.

FIG. 12 is a view similar to that of FIG. 5, showing a pillow according to either embodiment provided with the cover.

FIG. 13 is a detail view of a portion of the cover shown in FIGS. 11 and 12.

### DETAILED DESCRIPTION OF THE INVENTION

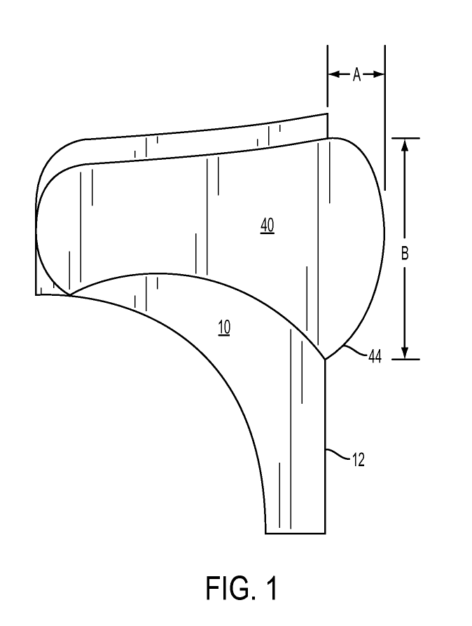

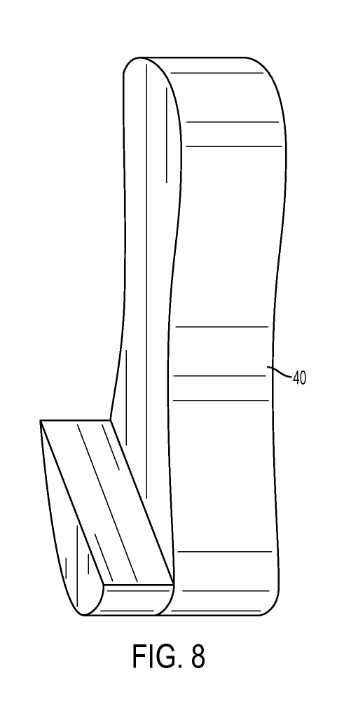

Referring to FIGS. 1-8, a article, or pillow, according to the first embodiment of the invention is constructed to provide improved support of at least the neck of a person seated on a seating article, such as a chair or vehicle seat, having a back or head rest that extends at least to, or higher than, the level of the neck, and preferably to the level of the occipital region, of a seated person of average height.

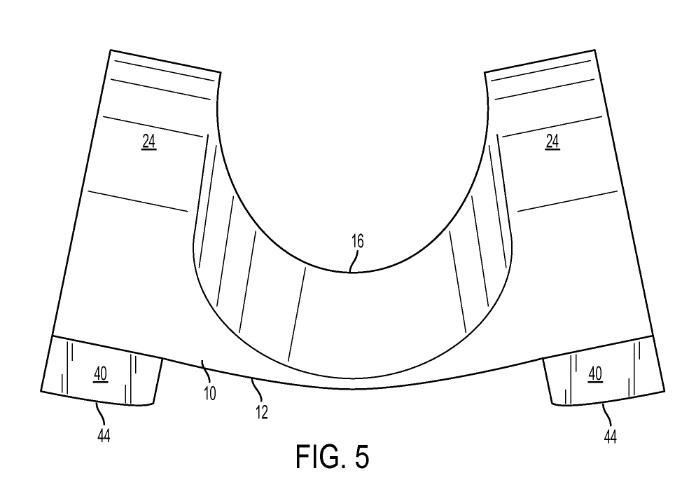

The article according to the invention includes a base member 10 made of a first resilient material having a first resiliency and having a rear main surface 12, two lateral edges 14, a front main surface 16 that will face the person when the article is in use, a top edge 18 and a bottom edge 20. A central portion of rear main surface 12 will bear against the seat back or head rest when the article is in use, as shown in FIG. 5.

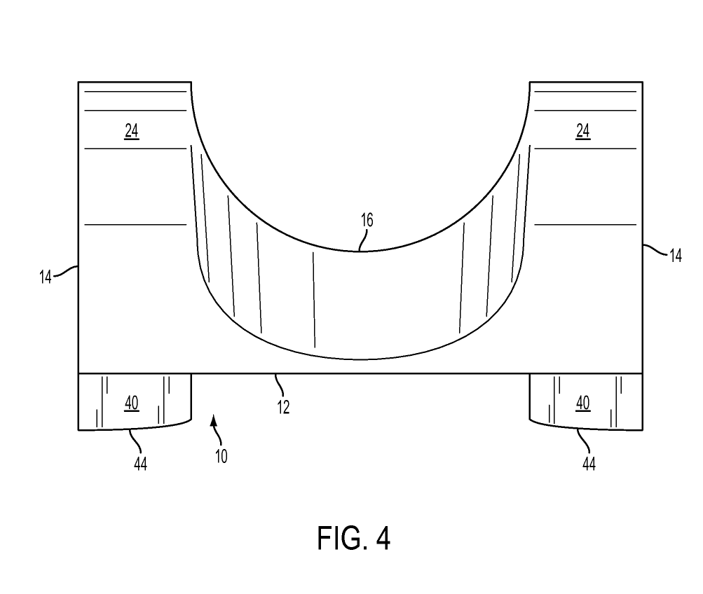

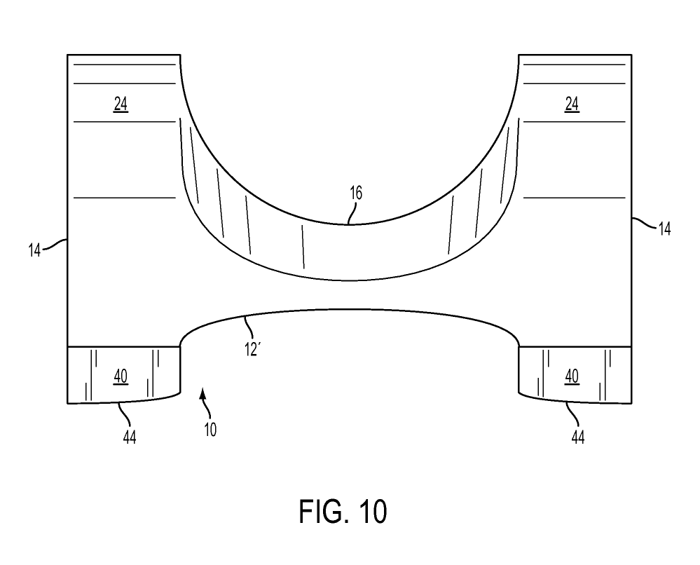

Rear main surface 12 of each embodiment disclosed herein, when the pillow is not in use, may be planar, as shown in FIG. 4, or concave, as shown in FIG. 10.

Along each lateral edge 14, base member 10 is provided with a respective lateral extension 24 that projects substantially horizontally in a forward direction from front main surface 16, substantially perpendicular to rear main surface 12 when the article is not in use.

Base member 10 is made in one piece and front main surface 16 is composed of an upper portion 16a and a lower portion 16b, these portions being spaced apart along lateral edges 14 and extending substantially vertically when the article is in use.

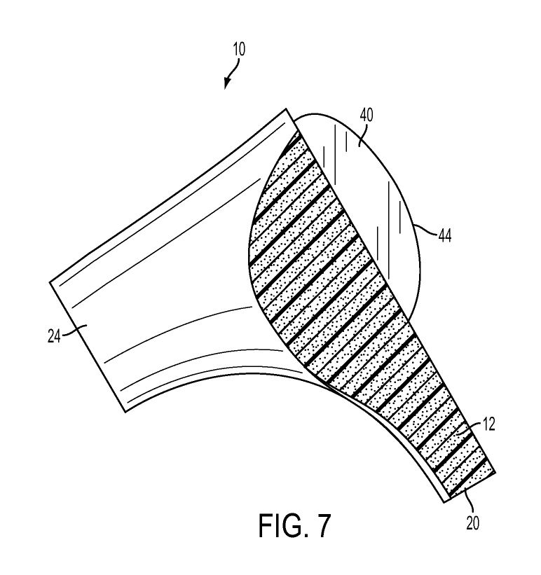

Upper portion 16a is convex in the plane of cross section line 7-7, i.e., in an approximately vertical plane, as shown particularly in FIG. 7, and is functionally concave in a plane perpendicular to the plane of cross section line 7-7, as shown in FIG. 4.

Upper portion 16a is substantially coextensive vertically with lateral extensions 24.

Lower portion 16b may have a central region that is slightly concave in a plane perpendicular to the plane of cross section line 7-7, and two relatively flat regions, each extending between the central region and a respective lateral edge 14.

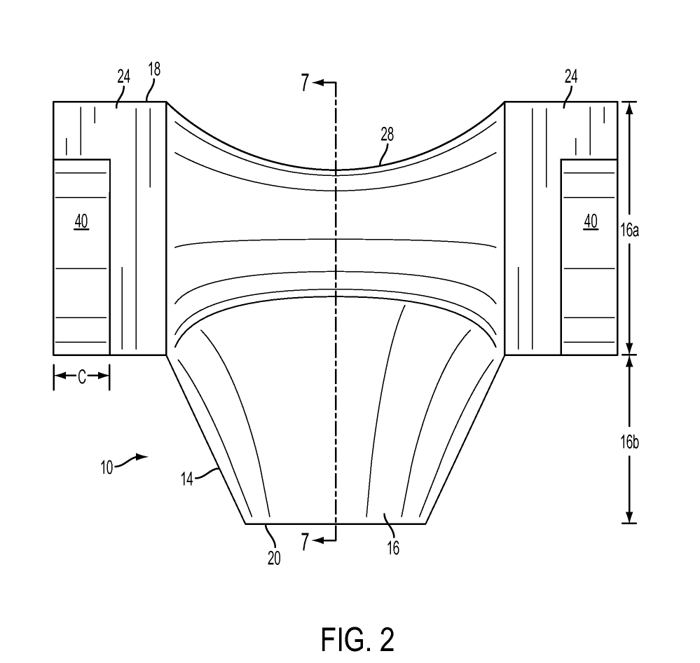

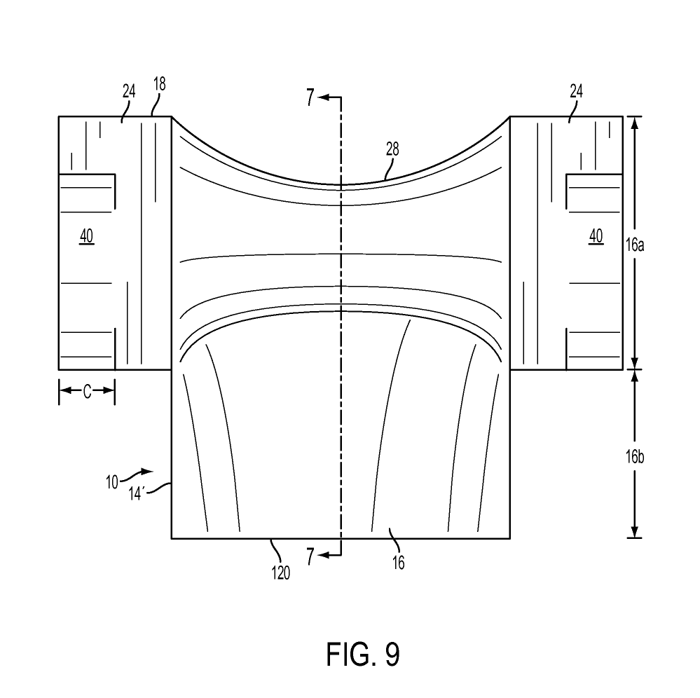

When viewed in the plane of FIG. 2, lower portion 16b may be tapered away from upper portion 16a, as shown in FIG. 2, or may have constant width, i.e., lateral edges 14 may be parallel to one another, as shown in FIG. 9. Either embodiment may have either of these lower portion configurations.

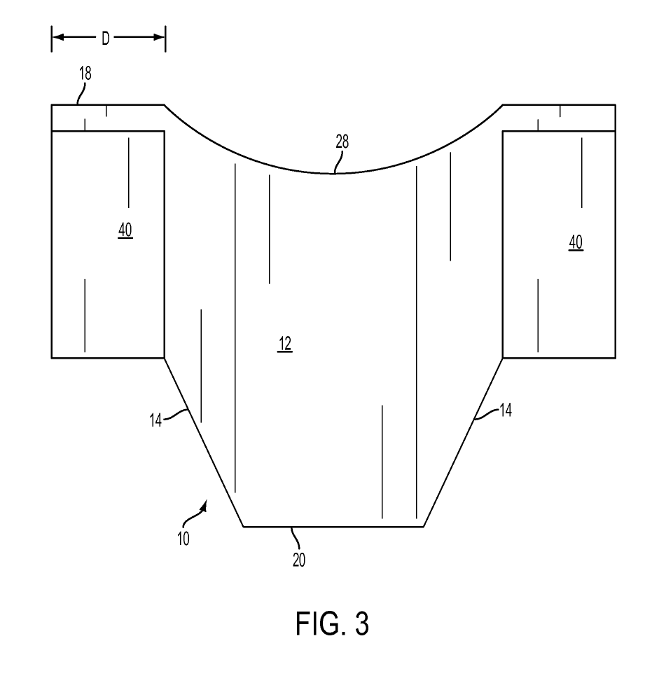

As shown in FIGS. 2 and 3, top edge 18 of base member 10 has a concave section 28 in the central portion of base member 10 to allow the person's head to rest against the seat back or headrest, while a part of upper portion 16a that is adjacent to concave section 28 may support the occipital region of the person's head.

The article according to the first embodiment is further provided with two lateral support members 40, which may be made of a second resilient material having a second resiliency that is less resilient than the first resiliency, or that may have the same composition and physical properties as the base member. Each support member 40 is secured, along a respective lateral edge 14 of base member 10, coextensive with upper portion 16a, to a respective lateral extension 24, as by, for example, cementing, gluing, or co-molding.

Each support member 40 has a generally L-shape with a rear length portion that extends rearwardly from base member 10 past rear main surface 12 and a front length portion that extends forwardly from base member 10 past front main surface 16. According to one preferred, but non-limiting, embodiment of the invention, the front length portion may have a width, C, of the order of 1 inch, the rear length portion may have a width, D, of the order of 2 inches, and the distance between support members 40 may be of the order of 8 inches, these dimensions being in a direction perpendicular to cross section plane 7-7 shown in FIG. 2.

Upper portion 16a of front main surface 16 is located between the two lateral support members 40.

Upper portion 16a of front main surface 16 is located to support the neck of the seated person and lower portion 16b is located to support an upper part of the back of the seated person, essentially the portion of the back that is between the shoulder blades. Lower portion 16b tapers toward bottom edge 20 and is generally thinner than upper portion 16a.

The rear length portion of each lateral support member 40 has a free end 44 that is convex in a direction parallel to the plane of cross section plane 7-7 of FIG. 2. Each free end 44 is also inclined or convexly curved in a direction perpendicular to the plane of cross section line 7-7, in a direction such that the lateral edge of the rear length portion that faces toward the center of the article is a shorter distance from rear main surface 12 than is the outer lateral edge of the rear length portion, which faces away from the center of the article.

Base member 10 and lateral support members 40 each preferably consists of a compressible, resilient foam material, preferably polyurethane foam. Other compressible, resilient materials, including other foam materials, such as foam rubber, may also be used.

According to preferred embodiments of the invention, the material of base member 10 may have a resiliency of HR (High Resiliency) 5-15 and the material of each lateral support member 40 may have a resiliency of HR-5-90. Polyurethane foams with resiliencies of HR10 and HR70, respectively have been found to provide the desired results, which will be described below.

FIGS. 9 and 10 illustrate the second embodiment of the invention, in which the base member and the lateral support members are formed as a one-piece, or integral, or unitary, structure having a uniform, homogeneous composition and physical properties. Otherwise, the second embodiment shown in FIGS. 9 and 10 has the same appearance as shown in FIGS. 2 and 4, respectively.

The primary differences are that, as shown in FIG. 9, lower portion 16b of base member 10 has a generally rectangular form, as seen in the plane of FIG. 9, with mutually parallel lateral edges 14′, and, as shown in FIG. 10, base member 10 has a concave rear main surface 12′.

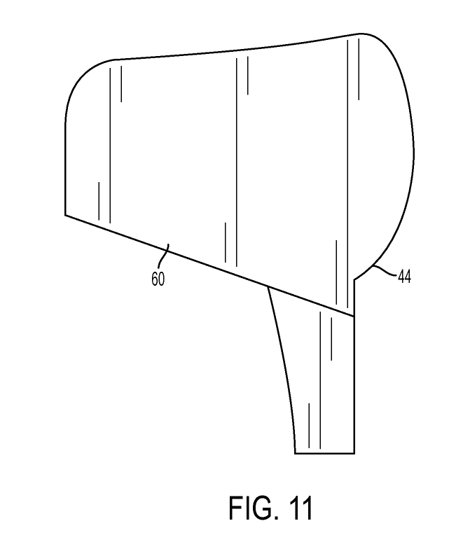

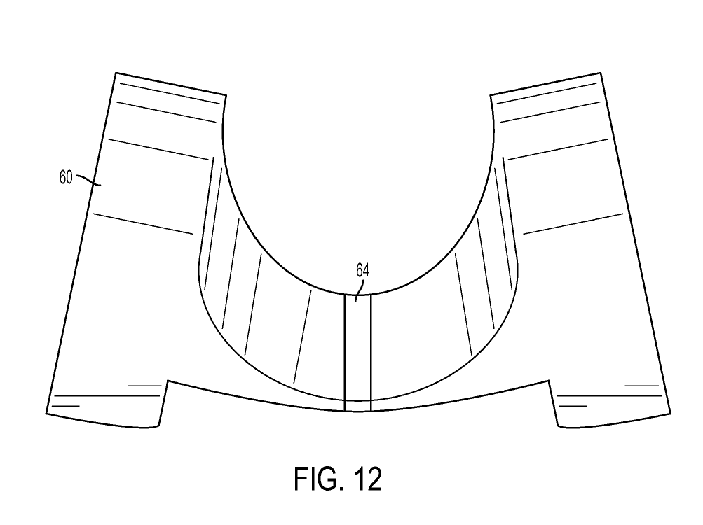

The article according to the invention will be further provided with a flexible and adjustable cover 60, represented in particular in FIGS. 11 and 12.

FIG. 11 also shows an alternative configuration for the pillow that differs from that shown in FIGS. 1-10 only in that each lateral support member has a generally trapezoidal form bounded by four straight lines in the plane of FIG. 11, and the upper surface of the base member extends i a straight line over the region of lower portion 16b, in the direction parallel to cross-section plane 7-7. Otherwise, the embodiment of FIG. 11 has the same form and functions of the embodiments previously disclosed.

Cover 60 is preferably essentially form fitting to the base member and lateral support members. Thus, the appearance of the article, in line drawings, when provided with such a cover will be essentially identical to that shown in FIGS. 9 and 10.

Cover 60 may be made of any suitable material used for covering flexible, compressible articles. The cover may be of any fabric or soft plastic. In more general terms, cover 60 may be made of any material that is employed in the field of upholstery.

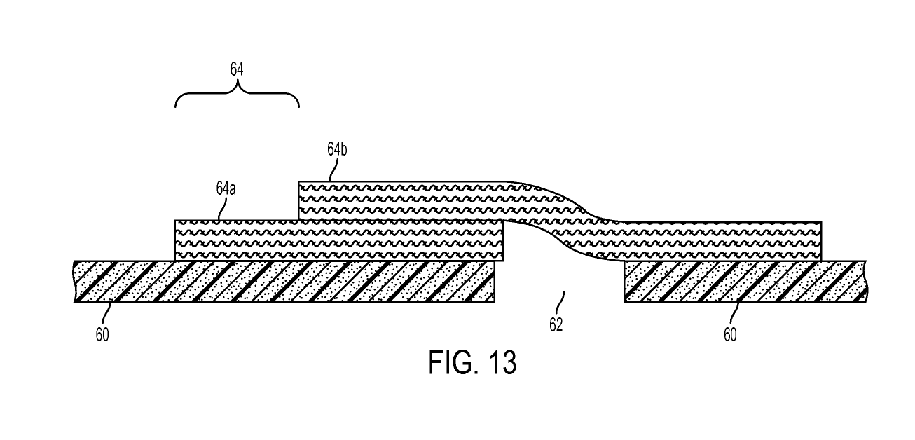

According to a further embodiment of the invention, and as shown in FIGS. 12 and 13, cover 60 may be provided with a slit 62, shown in FIG. 13, that extends along the entirety of front main surface 16 and the edges of base member adjoining surface 16 down to surface 12. For example, slit 62 could extend along cross-section line 7-7 of FIG. 9.

Slit 62 has two opposed longitudinal edges. Adjustment of the distance between the opposed edges will affect the degree of lateral support provided by the lateral support members.

In order to secure the portions of cover 60 at opposites sides of slit 62 together, and adjust the spacing between the opposed edges of slit 62, there is provided a connecting arrangement 64 composed of two flexible strips 64a and 64b constructed to be fastened together in order to maintain a desired spacing between the opposed edges of slit 62.

Strips 64a and 64b may be made of any suitable material, including any of the above-cited materials used for cover 60. Strips 64a and 64b may, for example, be provided with components of a hook-and-loop fastener, although other suitable fastening mechanisms will be apparent to those skilled in the art.

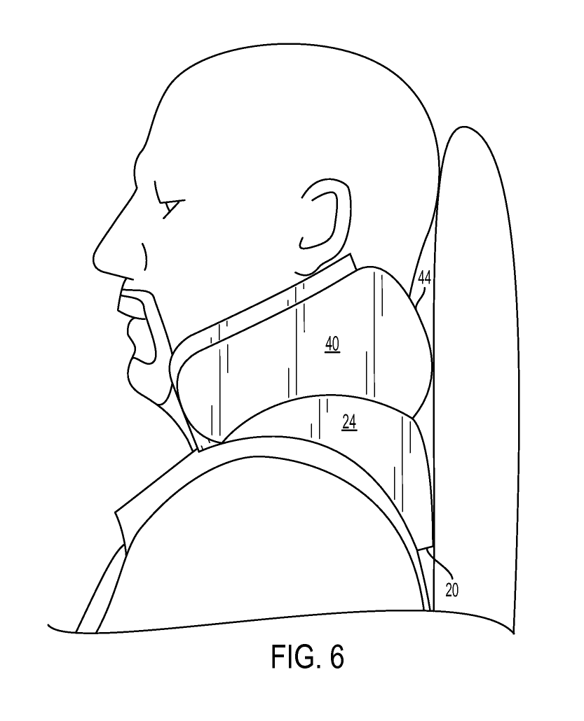

The dimensions and materials of the disclosed article are selected such that when the article is in use, i.e., when it is engaged by a seated person, as shown in FIG. 6, convex free ends 44 of the rear length portions of lateral support members 40 bear against the seat back and rearward pressure produced by the seated person's neck against upper portion 16a of front main surface 16 of base member 10 causes, as shown in FIG. 5, at least upper portion 16a to be deformed toward the seat back, causing the two lateral support members 40 and lateral extensions 24 to pivot inwardly toward and against the sides of the person's neck, thus creating a neck cradle that helps to support the person's head in an upright position. When the article, or pillow, according to the invention is provided with a concave rear main surface 12′, as shown in FIG. 10, increased lateral support is offered to the user's head, and possibly also the user's neck.

This deformation of upper portion 16a, and its adjustment to the user's head, neck and upper back, is aided by the inclination or curvature of free end 44 of each support member in a direction perpendicular to the plane of cross section line 7-7. Preferably, the free ends 44 are given a convex curvature having a radius of curvature selected to cause each free end 44 to roll against the seat back as upper portion 16a is being deformed in response to pressure applied by the user.

Satisfactory performance of the article requires that the centers of convex free ends 44 of the rear length portions of lateral support members 40 extend an appropriate distance, A, from the lateral edges of rear main surface 12, as shown in FIG. 1. The distance A may have a value of the order of −½ to 4 inches, a value of 1¼ inches having been found to provide a good result. In addition, the rear length portion of each support member 40 may have a length, B, shown in FIG. 1, parallel to the plane of cross section line 7-7, of the order of −3¾ inches, although this dimension can be varied.

At the same time, the convexity of free ends 44 of the rear length portions of lateral support members 40 in planes parallel to cross section plane 7-7 act to angularly orient, or pivot, the article in a vertical plane in order to maintain upper portion 16a of front main surface 16 in contact with the person's neck and to maintain lower portion 16b of front main surface 16 in contact with an upper part of the person's back.

The material of base member 10 is contoured to the upper thoracic, cervical and occipital areas that contact the base member and attaches to the lateral support members.

Lateral support members 40 may be made of a stiffer material that affords a more limited lateral flexion of the cervical spine.

The rear length portion of each lateral support member 40 having a convex free end 44 forms a rocker panel that is the foundation of the lateral support and neck cradle. These rocker panels provide (1) a self adjusting tilting (rocking) of the neck cradle along the sagittal plane, i.e., about horizontal axes, and (2) a self adjusting (lateral to medial) support along the coronal plane for the user.

The rocker panels, lateral support members 40 and lateral extensions 24 and the portion of base member 10 between lateral extensions 24 in combination form a rocker lateral support system that is deformed when the user leans back against base member 10 to form a neck cradle.

Lateral support members 40 provide lateral support to the article by attaching to lateral extensions 24. They provide self adjusting lateral stabilization by directing the effective size and weight of the user's own neck and head resting against the cradle. The gentle pressure directed towards the seat back results in this unique side support feature according to the present invention.

Support members 40 act to suspend base member 10 away from the seat back when a user is not leaning back against the article. As the user presses back against base member 10, the rocker lateral support system causes the article to be self-adjusting to the individual anatomical size, shape and preferences, thus creating a natural hammock effect of the cradle. Additionally, the rocker lateral support system offers increased adaptability to seat back variations.

The rocker lateral support system functions to provide a self-adjusting support for the concave posterior portion of the user's neck and lateral support for the sides of the neck and, in general, the anatomical circumference contour of the neck and occipital areas. The rocker lateral support system will self-adjust and adapt to varying seat back designs. It allows for soft base member 10 to provide a support that adapts to a wide variety of anatomical and seat dimensional factors without compromising the cradling effect it provides to the user.

Embodiments of the invention may be made with “Open cell” polyurethane HR (high resilient) foam having a wide range of density and resiliency values that determine how soft or hard the form is, and how durable it is.

For example, foam with a density of 1.7 (lbs. per cubic foot) and an IDL (Indentation Load Factor) of 15 is defined by the foam industry standard description label of 17/15 (very soft)

The foam used may have between at least an approximate rating of 17/15 (very soft) sometimes referred to as HR 10 and a rating of 22/50 (very firm), sometimes referred to as HR 50. For example, the base member of FIGS. 1-7 and the pillow of FIGS. 9-10 may be at the very soft end of the range and the rocker lateral support system FIGS. 1-8 may be at the very firm end of the range.

Thus, the article according to the invention provides a neck cradle that gently self-adjusts the amount of required lateral support to the cervical area, allows the occipital and cervical areas to self-adjust to the existing neck lordosis, and self-adjusts to the seat back to substantially eliminate pressure points on the user's body.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A article for improved support of at least the neck of a person seated on a seat having a back or head rest that extends at least to a level of the neck of a seated person of average height, said article comprising:
a base member made of a resilient material and having: a rear main surface that will bear against the seat back or head rest when said article is in use; two lateral edges, and a front main surface that will face the person when the article is in use, said front main surface being divided into an upper portion and a lower portion, said upper and lower portions being spaced apart along said lateral edges and extending substantially vertically when said article is in use; and
two lateral support members made of a resilient material, each said support member being secured along a respective lateral edge of said base member and each having a rear length portion that extends rearwardly from said base member past said rear main surface and a front length portion that extends forwardly from said base member past said front main surface,
wherein:
said upper portion of said front main surface is located between said two lateral support members; and
said upper portion of said front main surface is convex in a plane that is transverse to said rear main surface and that extends between said two lateral support members.

2. The article of claim 1, wherein said upper portion of said front main surface is located to support the neck of the seated person and said lower portion of said front main surface is located to support an upper part of the back of the seated person.

3. The article of claim 2, wherein said rear length portion of each of said lateral support members has a free end that is convex in a direction parallel to said plane.

4. The article of claim 2, wherein said base member further has two lateral extensions, each contacting an interior surface of a respective one of said lateral support members, such that each of said lateral extensions will be interposed between the respective one of said lateral support members and a user's neck when said article is in use.

5. The article of claim 2, wherein each of said base member and said lateral support members consists of a compressible, resilient foam material.

6. The article of claim 5, wherein said foam material is polyurethane foam.

7. The article of claim 2, wherein the dimensions and materials of said article are selected such that when said article is in use, said convex free ends of said rear length portions of said lateral support members bear against the seat back and rearward pressure produced by the seated person's neck against said upper portion of said front main surface of said base member causes said upper portion to be deformed toward the seat back, causing said two lateral support members to pivot toward the sides of the person's neck to create a neck cradle.

8. The article of claim 7, wherein said convex free ends of said rear length portions of said lateral support members are adapted to rotate said article in a vertical plane in order to maintain said upper portion of said front main surface in contact with the person's neck and said lower portion of said front main surface in contact with an upper part of the person's back.

9. The article of claim 8, wherein said convex free ends of said rear length portions of said lateral support members are adapted to roll on the seat back in a horizontal direction as said upper portion of said front main surface of said base member is deformed toward the seat back.

10. The article of claim 1, wherein said article, including said base member and said lateral support members is made of a single piece of resilient material

11. The article of claim 10, wherein said single piece of resilient material has uniform, homogeneous physical properties.

12. The article of claim 1, wherein the resilient material of said lateral support members is less resilient than the resilient material of said base member.

13. The article of claim 1, further comprising a flexible cover enclosing said base member and said lateral support members.

14. The article of claim 13, wherein said flexible cover has a slit with two opposed edges and comprises a fastening member connected to secure said opposed edges of said slit of said flexible cover with an adjustable spacing between said opposed edges of said slit.
